(19) United States
(12) Patent Application Publication
(10) Pub. No.: US 2001/0041761 A1
(43) Pub. Date: Nov. 15, 2001

(54) Polypropylene resin composition, and molded article and film prepared therefrom

(76) Inventors: Yoshiaki Oobayashi, Ichihara-shi (JP); Shigeki Kishiro, Ichihara-shi (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/797,806

(22) Filed: Mar. 5, 2001

(30) Foreign Application Priority Data
Mar. 8, 2000 (JP) 2000-063457

(51) Int. Cl. C08K 5/29

(52) U.S. Cl. 524/197; 524/434; 524/436; 524/583; 524/584

(57) ABSTRACT

A polypropylene resin composition comprising 100 parts by weight of a polypropylene resin, 0.001 part by weight or more and less than 0.03 parts by weight of an alkaline earth metal hydroxide and 0.01 part by weight or more and less than 0.5 parts by weight of a phenol antioxidant, a molded product and a film prepared therefrom. The composition is excellent in thermal stability, makes less dirty a processing machine on processing and is less fuming.

### BACKGROUND OF THE INVENTION

1. Field of the Invention

The present invention relates to a polypropylene resin composition and a molded product and a film prepared from the composition. More precisely, it relates to a polypropylene resin composition containing a polypropylene resin, a specific amount of an alkaline earth metal hydroxide and a specific amount of a phenol antioxidant, which is excellent in thermal stability, makes less dirty a processing machine on processing and is less fuming, and to a molded product and a film prepared therefrom.

2. Description of Related Arts

Polypropylene resins have been used for wide application in fields including wrapping field such as food wrapping, fiber wrapping and so on, medical applications, containers, electric home appliances, interior and exterior trim parts of automobile and so on, because of their superior extrusion-molding processability, appearance, mechanical characteristics, chemical resistance, adaptability to wrapping application and so on. Propylene resins are generally melt-kneaded under heating usually at a temperature range of 180° C. to 300° C. using an extruder or the like, pelletized and molded to various articles according to purpose and use. Propylene resins, however, had a problem that they were liable to be decomposed by the shearing force of extruder applied to the resins during the molding or the heat at a high temperature. The decomposition was promoted by a residue of catalyst such as a halogen, a transition metal or the like remained in the resins.

As means for improving this problem, a method in which a neutralizing agent and a stabilizer are added has been known. For example, JP-A-49-3947 discloses a polypropylene resin composition containing 0.2 to 1% by weight of calcium hydroxide and 0.04% by weight of a phenol antioxidant on the basis of polypropylene.

While the polypropylene resin composition containing the conventionally known polypropylene resin, a neutralizing agent and a stabilizer was somewhat improved in thermal stability and the decomposition thereof was suppressed at a certain degree, it has still problems that a hue of the polypropylene resin composition, or the molded article or the film prepared therefrom is deteriorated, that a fume is generated, and that a processing machine such as a roll becomes dirty, due to the decomposition of the polypropylene resin caused by catalyst residues, neutralizing agent and so on, or decomposition of the antioxidant.

### SUMMARY OF THE INVENTION

An object of the present invention is to provide a polypropylene resin composition which is free from deterioration of hue, free from fuming during processing and free from dirty of a processing machine, as well as a molded product and a film prepared therefrom.

As the result of extensive studies conducted under these circumstances, the present inventors have found that the above problems can be solved by using a polypropylene resin composition containing a polypropylene resin, a specific amount of an alkaline earth metal hydroxide and a specific amount of a phenol antioxidant and completed the present invention.

Namely, the present invention relates to a polypropylene resin composition comprising 100 parts by weight of a polypropylene resin, 0.001 part by weight or more and less than 0.03 part by weight of an alkaline earth metal hydroxide (A) and 0.01 to 0.5 part by weight of a phenol antioxidant (B), and further a molded article and a film prepared from the above polypropylene resin composition.

The invention will be described below in detail.

### DETAILED DESCRIPTION OF THE INVENTION

The polypropylene resin used in the invention includes homopolymers of propylene, random copolymers of propylene, block copolymers of propylene and so on. The random copolymers of propylene preferably include random copolymers of propylene with ethylene and/or an α-olefin having at least 4 carbon atoms, and specifically a propylene-ethylene random copolymer, propylene-a-olefin random copolymer and propylene-ethylene-α-olefin random copolymer.

The block copolymers of propylene are copolymers which are produced by a multi-steps polymerization containing at least two steps, in which a polymer component composed of propylene alone or as a main component is produced in at least one polymerization step, and a copolymer component comprising propylene, and ethylene and/or α-olefin having 4 to 12 carbon atoms is produced in at least one polymerization step different therefrom. Examples thereof include a propylene-ethylene block copolymer which is produced by polymerizing propylene alone in the first step and propylene and ethylene are randomly copolymerized in the second step, and the like.

Preferred one is a propylene block copolymer which is produced by a multi-step polymerization composed of at least two steps or more, in which a polymer component composed of propylene alone or as a main component is produced in at least one polymerization step, and a copolymer component comprising propylene, ethylene and/or α-olefin having 4 to 12 carbon atoms is produced in at least one different polymerization step.

Examples of the α-olefin having 4 to 12 carbon atoms include 1-butene, 1-pentene, 1-hexane, 1-octene, 1-decene and the like, and preferably 1-butene, 1-hexane and 1-octene.

Contents of ethylene and/or α-olefin having 4 to 12 carbon atoms in the copolymer are not particularly limited and preferably 0.1 to 20% by weight, more preferably 1 to 10% by weight.

As the polypropylene resin used in the invention, propylene homopolymers and copolymers as described above can be used alone or in a blend of two or more.

The Melt index (MI, measured at 230° C. and under a load of 2.16 kg according to JIS K7210 of the polypropylene resin used in the invention is not particularly limited and preferably 0.01 to 300 g/10 minutes, more preferably 0.1 to 100 g/10 minutes.

The polypropylene resin used in the present invention can be obtained with a stereoregular polymerization catalyst. Examples of the stereoregular catalyst includes (1) a Ziegler-Natta catalyst containing a Ti component, Al component, Mg component as essential components, (2) ametallocene catalysts containing a transition metal compound of the group IV in the Periodic Table of the Elements having a cyclopentadienyl ring and an alkylaluminoxane as essential components, (3) a metallocene catalyst containing a transition metal compound of the group IV in the Periodic Table of the Elements having a cyclopentadienyl ring, a compound capable of reacting therewith to form an ionic complex and an organic aluminum compound as essential components, and the like.

The process for producing the polypropylene resin used in the invention is not particularly limited and may include various polymerization methods. Examples include a slurry polymerization method or solution polymerization method using an inert hydrocarbon solvent, a liquid phase polymerization method (bulk polymerization in a liquefied monomer(e.g. propylene, etc.)) or gas phase polymerization method using no solvent. These polymerization methods may be conducted batchwise or continuously and may include methods in which a continuous liquid phase polymerization method (bulk polymerization in a liquefied monomer(e.g. propylene, etc.))and a continuous gas phase polymerization method are successively conducted. Preferred method is a gaseous polymerization method or a liquid phase-gaseous phase polymerization method.

In the process for producing the polypropylene resin used in the invention, a de-ashing treatment for removing the catalyst residue remained in the product may or may not be conducted. A polymerization method using a polymerization catalyst with a high activity enough to make the de-ashing treatment unnecessary, is preferable.

The polypropylene resin or the polypropylene resin composition may be used after drying in order to remove a remained solvent, a oligomer of ultra low molecular weight produced as a byproduct in the production, and the like. Examples of the drying method include a method drying the polypropylene resin or the polypropylene resin composition at a temperature lower than the melting point of those as described in JP-A-55-75410 or JP-B-2565753).

As the alkaline earth metal in the alkaline earth metal hydroxide (A) used in the present invention, alkaline earth metal atoms of the group II of the Periodic Table of the Elements (IUPAC Nomenclature in Inorganic Chemistry, 1989 revision) are listed. Examples thereof include a magnesium atom, calcium atom and the like, and preferably a calcium atom.

Examples of the alkaline earth metal hydroxide (A) include magnesium hydroxide, calcium hydroxide and the like, and preferably calcium hydroxide.

The shape and property of the alkaline earth metal hydroxide (A) are not particularly limited. Powdery alkaline earth metal hydroxide (A) is usually used in view of the dispersability in the polypropylene resin.

The average particle diameter of the alkaline earth metal hydroxide (A) is not particularly limited and usually 50 μm or less, preferably 10 μm or less and most preferably 5 μm or less.

The amount used of the alkaline earth metal hydroxide (A) is 0.001 part by weight or more and less than 0.03 parts by weight based on 100 parts by weight of the polypropylene resin. Preferably, the amount is 0.001 to 0.02 parts by weight, and more preferably 0.005 to 0.01 part by weight.

When the amount of the alkaline earth metal hydroxide (A) is less than 0.001 part by weight based on 100 parts by weight of the polypropylene resin, sometimes corrosion (rusting) problem of a processing machine may occur due to insufficient inactivation of residual catalyst. To the contrary, when it is more than 0.03 part by weight, discoloration of the polypropylene resin composition, and the molded product and film may occur. Moreover, such amount is unnecessary from the economical viewpoint.

Examples of the phenol antioxidant (B) used in the present invention include hindered phenol antioxidants such as 2,6-di-t-butyl-4-methylphenol, pentaerythrityl-tetrakis [3-(3,5-di-t-butyl-4- hydroxyphenyl)propionate], octadecyl-3-(3,5-di-t-butyl-4-hydroxyphenyl)propionate, 3,9-bis[2-{3-(3-t-butyl-4-hydroxy-5-methylphenyl)propionyloxy}-1,1-dimethylethyl]-2,4,8,10-tetraoxaspiro[5.5]undecane, 1,3,5-tris2[3-(3,5-di-t-butyl-4-hydroxyphenyl)propionyloxy] ethyl isocyanate, 1,3,5-trimethyl-2,4,6-tris-(3,5-di-t-butyl-4-hydroxybenzyl)benzene, tris-(3,5-di-t-butyl-4-hydroxybenzyl)isocyanurate, 1,3,5-tris(4-t-butyl-3-hydroxy-2,6-dimethylbenzyl) isocyanurate, triethylene glycol-N-bis-3-(3-t-butyl-5-methyl-4-hydroxyphenyl)propionate, 1,6-hexanediol bis[3-(3,5-di-t-butyl-4-hydroxyphenyl) propionatel], 2,2-thiobis-diethylenebis[3-(3,5-di-t-butyl-4-hydroxyphenyl )propionate], 2,2′-methylenebis(4-methyl-6-t-butylphenol), 2,2′-methylenebis(4-ethyl-6-t-butylphenol), 2,2′-methylenebis(4,6-di-t-butylphenol), 2,2′-ethylidenebis(4,6-di-t-butylphenol)(Cheminox 1129), 2,2′-butylidenebis(4-methyl-6-t-butylphenol), 4,4′-butylidenebis(3-methyl-6-t-butylphenol), 2-t-butyl-6-(3-t-butyl-2-hydroxy-5-methylbenzyl)-4-methylphenyl acrylate, 2,4-di-t-amyl-6-[1-(3,5-di-t-amyl-2-hydroxyphenyl)ethyl] phenyl acrylate and the like.

Among phenol antioxidants, preferred are those having at least one group represented by the general formula (I):

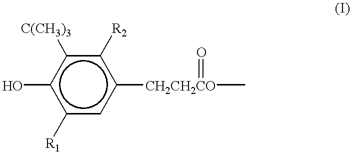

wherein R₁ and R₂ represent hydrogen, a methyl group or a t-butyl group and they may be the same or different, or 1,3,5-tris(3,5-di-t-butyl-4-hydroxybenzyl)isocyanurate.

Examples of the phenol antioxidant having at least one group represented by the general formula (I) described above include pentaerythrityl-tetrakis[3-(3,5-di-t-butyl-4-hydroxyphenyl)propionate], octadecyl-3-(3,5-di-t-butyl-4-hydroxyphenyl)propionate, 3,9-bis[2-{3-(3-t-butyl-4-hydroxy-5-methylphenyl) propionyloxy}-1,1-dimethylethyl]-2,4,8,10-tetraoxaspiro[5.5]undecane, triethylene glycol-N-bis-3- (3-t-butyl-5-methyl-4-hydroxyphenyl) propionate, 1,6-hexanediol bis[3-(3,5-di-t-butyl-4-hydroxyphenyl) propionate], 2,2-thiobis-diethylenebis [3- (3, 5-di-t-butyl-4-hydroxyphenyl) propionate] and the like.

The amount of the phenol antioxidant (B) is 0.01 to 0.5 parts by weight based on 100 parts by weight of the polypropylene resin, preferably 0.01 to 0.3parts by weight, and more preferably 0.01 to 0.2 parts by weight.

When the amount of the phenol antioxidant (B) is less than 0.01 part by weight based on 100 parts by weight of the polypropylene resin, decomposition of the polypropylene resin during processing may occur due to insufficient thermal stability of the polypropylene resin. In addition, various properties of the polypropylene resin composition, and the molded product and film prepared therefrom may become insufficient.

When the amount is more than 0.5 parts by weight, processing machines may be stained during processing, and hue of the polypropylene resin composition, or the molded product and film prepared there from may be deteriorated. In particular, in the processing of a film, whitening phenomenon or the like may occur due to bleeding out of the phenol antioxidant on the surface of the film, and the appearance may be deteriorated.

The polypropylene resin composition used in the present invention may contain other additives insofar as the object and effect of the invention are not adversely affected. Examples of the additives include phosphor antioxidants, sulfur antioxidants, UV absorbers, light stabilizer, hydroxylamine stabilizers, plasticizers, flame retardant, nucleating agent, metal inactivating agent, antistatic agents, pigments, anti-blocking agents, surfactants, processing aids, foaming agents, emulsifiers, gloss agents, coloring improving agent, auxiliary stabilizer and the like. Particularly, a phosphor antioxidant is preferably used as a fabrication stabilizer.

Examples of the phosphorus antioxidant include triphenyl phosphite, tris(nonylphenyl) phosphite, tris(2,4-di-t-butylphenyl)phosphite, trilauryl phosphite, trioctadecylphosphite, distearyl pentaerythritol diphosphite, diisodecyl pentaerythritol diphosphite, bis(2,4-di-t-butylphenyl) pentaerythritol diphosphite, bis(2,4-di-t-butyl-6-methylphenyl) pentaerythritol diphosphite, bis(2,6-di-t-butyl-4-methylphenyl) pentaerythritol diphosphite, bis(2,4,6-tri-t-butylphenyl) pentaerythritol diphosphite, tristearyl sorbitol triphosphite, tetrakis(2,4-di-t-butylphenyl)-4,4′-diphenylene diphosphonite, 2,2′-methylenebis(4,6-di-t-butylphenyl)-2-ethylhexyl phosphite, 2,2′-ethylidenebis(4,6-di-t-butylphenyl) fluorophosphite, bis(2,4-di-t-butyl-6-methylphenyl)ethyl phosphite, bis(2,4-di-t-butyl-6-methylphenyl)methyl phosphite, 2-(2,4,6-tri-t-butylphenyl)5-ethyl-5-butyl-1,3,2-oxaphosphorinane, 2,2′, 2″-nitrilo[triethyl-tris(3,3′, 5,5′-tetra-t-butyl-1,1′-biphenyl-2,2′-diyl) phosphite, 2,4,8,10-tetra-t-butyl-6-[3-(3-methyl-4-hydroxy-5-t-butylphenyl)propoxy]dibenzo[d,f][1,3,2] dioxaphosphepine, mixtures containing two or more of them and the like.

Particularly, when the polypropylene resin composition used in the invention is used for a wrapping film for foods, phosphorus stabilizers superior in hydrolysis resistance are preferred in view of taste, odor and the like. Examples of such phosphor stabilizer include tris(2,4-di-t-butylphenyl) phosphate, bis(2,4-di-t-butyl-6-methylphenyl) pentaerythritol diphosphite, 2,4,8,10-tetra-t-butyl-6-[3-(3-methyl-4-hydroxy-5-t-butylphenyl)propoxy]dibenzo[d,f] [1,3,2]dioxaphosphepine.

Examples of the sulfur antioxidant include dilauryl 3,3′-thiodipropionate, tridecyl 3,3′-thiodipropionate, dimyristyl 3,3′-thiodipropionate, distearyl 3,3′-thiodipropionate, lauryl stearyl 3,3′-thiodipropionate, neopentanetetrayltetrakis(3-laurylthiopropionate), mixtures containing two or more of them.

Examples of the ultraviolet absorber include (1) salicylate derivatives, (2) 2-hydroxybenzophenone derivatives, (3) 2-(2′-hydroxyphenyl)benzotriazole derivatives and the like.

### (1) salicylate derivatives

Examples of the salicylate derivatives include phenyl salicylate, 4-t-butylphenyl salicylate, 2,4-dit-butylphenyl 3′, 5′-di-t-butyl-4′-hydroxybenzoate, 4-t-octylphenyl salicylate, bis(4-t-butylbenzoyl)resorcinol, benzoyl resorcinol, hexadecyl 3′, 5′-di-t-butyl-4′-hydroxybenzoate, octadecyl 3′, 5′-di-t-butyl-4′-hydroxybenzoate, 2-methyl-4,6-di-t-butylphenyl 3′, 5′-di-t-butyl-4′-hydroxybenzoate, mixtures containing two or more of them and so on.

### (2) 2-hydroxybenzophenone derivatives

Examples of the 2-hydroxybenzophenone derivatives include 2,4-dihydroxybenzophenone, 2-hydroxy-4-methoxybenzophenone, 2-hydroxy-4-octyloxybenzophenone, 2,2′-dihydroxy-4-methoxybenzophenone, bis(5-benzoyl-4-hydroxy-2-methoxyphenyl)methane, 2,2′4,4′-tetrahydroxybenzophenone, mixtures containing two or more of them and so on.

### (3) 2-(2′-hydroxyphenyl)benzotriazole derivatives

Examples of the 2-(2′-hydroxyphenyl)benzotriazole derivatives include 2-(2-hydroxy-5-methylphenyl)benzotriazole, 2-(3′, 5′-di-t-butyl-2′-hydroxyphenyl)benzotriazole, 2-(5′-t-butyl-2′-hydroxyphenyl)benzotriazole, 2-(2′-hydroxy-5′-t-octylphenyl)benzotriazole, 2-(3-t-butyl-2-hydroxy-5-methylphenyl) -5-chlorobenzotriazol e, 2-(3′-s-butyl-2′-hydroxy-5-t-butylphenyl)benzotriazole, 2-(2′-hydroxy-4′-octyloxyphenyl)benzotriazole, 2-(3′, 5′-di-t-amyl-2′-hydroxyphenyl)benzotriazole, 2-[2′-hydroxy-3′, 5′-bis(á,á-dimethylbenzyl)phenyl]-2H-benzo triazole, 2-[(3′-t-butyl-2′-hydroxyphenyl)-5′-(2-octyloxycarbonylethyl)phenyl]-5-chlorobenzotriazole, 2-[3′-t-butyl-5′-[2-(2-ethylhexyloxy)carbonylethyl]-2′-hydroxyphenyl]-5-chlorobenzotriazole, 2-[3′-t-butyl-2′-hydroxy-5′-(2-methoxycarbonylethyl)phenyl] -5-chlorobenzotriazole, 2-[3′-t-butyl-2′-hydroxy-5′-(2-methoxycarbonylethyl)phenyl]benzotriazole, 2-[3′-t-butyl-2′-hydroxy-5′-(2- octyloxycarbonylethyl) phenyl]benzotriazole, 2-[3′-t-butyl-2′-hydroxy-5′-[2-(2-ethylhexyloxy)carbonylethyl]phenyl]benzotriazole, 2-[2-hydroxy-3-(3,4,5,6- tetrahydrophthalimidomethyl)-5-methylphenyl]benzotriazole, 2-(3,5-di-t-butyl-2-hydroxyphenyl)-5-chlorobenzotriazole, a mixture of 2-(3′-dodecyl-2′- hydroxy-5′-methylphenyl) benzotriazole and 2-[3′-t-butyl-2′-hydroxy-5′-(2-isooctyloxycarbonylethyl)phenyl]benzotriazole, 2,2′-methylenebis[6-(2H-benzotriazole-2-yl)-4-(1,1,3,3-tetramethylbutyl)phenol], 2,2′-methylenebis[4-t-butyl-6-(2H-benzotriazole-2-yl)phenol], a condensate of poly(3˜11)(ethyleneglycol) with 2-[3′-t-butyl-2′-hydroxy-5′-(2-methoxycarbonylethyl)phenyl]benzotriazole, a condensate of poly(3˜11)(ethyleneglycol) with methyl 3-[3-(2H-benzotriazole-2-yl)-5-t-butyl-4-hydroxyphenyl]propionate, 2-ethylhexyl 3-[3-t-butyl-5-(5-chloro-2H-benzotriazole-2-yl)-4-hydroxyphenyl]propionate, octyl 3-[3-t-butyl-5-(5-chloro-2H-benzotriazole-2-yl) -4-hydroxyphenyl]propionate, methyl 3-[3-t-butyl-5-(5-chloro-2H-benzotriazole-2-yl)-4-hydroxyphenyl]propionate, 3-[3-t-butyl-5-(5-chloro-2H-benzotriazole-2-yl)-4-hydroxyphenyl]propionic acid, mixtures containing two or more of them and so on.

Examples of the light stabilizer include (1) hindered amine light stabilizers, (2) acrylate light stabilizers, (3) nickel light stabilizers, (4) oxamide light stabilizers, (5) 2-(2-hydroxyphenyl)-1,3,5-triazine light stabilizers and the like.

### (1) hindered amine light stabilizers

Examples of the hindered amine light stabilizers include bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(N-octyloxy-2,2,6,6-tetramethyl-4-piperidyl) sebacate, bis(N-benzyloxy-2,2,6,6-tetramethyl-4-piperidyl) sebacate, bis(N-cyclohexyloxy-2,2,6,6-tetramethyl-4-piperidyl) sebacate, bis(1,2,2,6,6-pentamethyl-4-piperidyl) 2-(3,5-di-t-butyl-4-hydroxybenzyl)-2-butylmalonate, bis(1-acryloyl-2,2,6,6-tetramethyl-4-piperidyl) 2,2-bis(3,5-di-t-butyl-4-hydroxybenzyl)-2-butylmalonate, bis(1,2,2,6,6-pentamethyl-4-piperidyl) decanethioate, 2,2,6,6-tetramethyl-4-piperidyl methacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6,6 -tetramethylpiperidine, 2-methyl-2-(2,2,6,6-tetramethyl-4-piperidyl)amino-N-(2,2,6, 6-tetramethyl-4-piperidyl)propionamide, tetrakis(2,2,6,6-tetramethyl-4-piperidyl) 1,2,3,4-butanetetracarboxylate, tetrakis(1,2,2,6,6-pentamethyl-4-piperidyl) 1,2,3,4 -butanetetracarboxylate, a mixed esterification product of 1,2,3,4-butanetetracarboxylic acid with 1,2,2,6,6-pentamethyl-4-piperidinol and 1-tridecanol, a mixed esterification product of 1,2,3,4-butanetetracarboxylic acid with 2,2,6,6-tetramethyl-4-piperidinol and 1-tridecanol, a mixed esterification product of 1,2,3,4-butanetetracarboxylic acid with 1,2,2,6,6-pentamethyl-4-piperidinol and 3,9-bis(2-hydroxy-1,1-dimethylethyl)-2,4,8,10-tetraoxaspiro [5.5]undecane, a mixed esterification product of 1,2,3,4-butanetetracarboxylic acid with 2,2,6,6-tetramethyl-4-piperidinol and 3,9-bis(2-hydroxy-1,1-dimethylethyl)-2,4,8,10-tetraoxaspiro [5.5]undecane, a polycondensate of dimethyl succinate with 1(2-hydroxyethyl)-4-hydroxy-2,2,6,6-tetramethylpiperidine, poly[(6-morpholino-1,3,5-triazine-2,4-diyl)((2,2,6,6-tetram ethyl-4-piperidyl)imino)hexamethylene((2,2,6,6-tetramethyl-4-piperidyl)imino)], poly[(6-(1,1,3,3-tetramethylbutyl) imino-1,3,5-triazine-2,4-diyl)((2,2,6,6-tetramethyl-4-piper idyl)imino)hexamethylene((2,2,6,6-tetramethyl-4-piperidyl)i mino)], a polycondensate of N,N′-bis(2,2,6,6-tetramethyl-4-piperidyl)hexamethylenediamine with 1,2-dibromoethane, N,N′,4,7-tetrakis[4,6-bis(N-butyl-N-(2,2,6,6-tetramethyl-4-piperidyl)amino)-1,3,5-triazine-2-yl]-4,7-diazadecane-1,10-diamine, N,N′,4-tris[4,6-bis(N-butyl-N-(2,2,6,6-tetramethyl -4-piperidyl)amino)-1,3,5-triazine-2-yl]-4,7-diazadecane-1, 10-diamine, N,N′,4,7-tetrakis[4,6-bis(N-butyl-N-(1,2,2,6,6-pentamethyl-4-piperidyl)amino)-1,3,5-triazine-2-yl]-4,7-diazadecane-1,10-diamine, N,N′,4-tris[4,6-bis (N-butyl -N-(1,2,2,6,6-tetramethyl-4-piperidyl)amino) -1,3,5-triazine-2-yl]-4,7-diazadecane-1,10-diamine, mixtures containing two or more of them and so on.

### (2) acrylate light stabilizers

Examples of acrylate light stabilizers include ethyl α -cyano-β, β-diphenylacrylate, isooctyl α-cyano-β, β -diphenylacrylate, methyl α-carbomethoxycinnamate, methyl α -cyano-β-methyl-p-methoxycinnamate, butyl α-cyano-β -methyl-p-methoxycinnamate, methyl α -carbomethoxy-p-methoxycinnamate, N-( β-carbomethoxy-β -cyanovinyl) -2-methylindoline, mixtures containing two or more of them and so on.

### (3) nickel light stabilizers

Examples of nickel light stabilizers include a nickel complex of 2,2′-thiobis[4-(1,1,3,3-tetramethylbutyl)phenol, nickel dibutyldithiocarbamate, a nickel salt of a monoalkylester, a nickel complex of a ketoxime, mixtures containing two or more of them and so on.

### (4) oxamide light stabilizers

Examples of the oxamide light stabilizers include 4,4′-dioctyloxyoxanilide, 2,2′-diethoxyoxanilide, 2,2′-dioctyloxy-5,5′-di-t-butylanilide, 2,2′-didodecyloxy-5,5′-di-t-butylanilide, 2-ethoxy-2′-ethyloxanilide, N,N′-bis(3-dimethylaminopropyl)oxamide, 2-ethoxy-5-t-butyl-2′-ethoxyanilide, 2-ethoxy-5,4′-di-t-butyl-2′-ethyloxanilide, mixtures containing two or more of them and so on.

### (5) 2-(2-hydroxyphenyl)-1,3,5-triazine light stabilizers

Examples of the 2-(2-hydroxyphenyl)-1,3,5-triazine light stabilizer include 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-[2,4-dihydroxyphenyl-4,6-bis(2,4-dimethylphenyl)]-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3, 5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropoxy)phenyl]-4,6-bis (2,4-dimethylphenyl)-1,3,5-triazine, 2-[2-hydroxy-4-(2-hydroxy-3-octyloxypropoxy)phenyl]-4,6-bis (2,4-dimethylphenyl)-1,3,5-triazine, mixtures containing two or more of them and so on.

Examples of the metal inactivating agent include N,N-diphenyloxamide, N-salicylal-N′-salicyloylhydrazine, N,N′-bis(salicyloyl)hydrazine, N,N′-bis(3,5-di-t-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-bis(salicyloyl)oxalyl dihydrazide, N,N′-bis(salicyloyl)thiopropionyl dihydrazide, mixtures containing two or more of them and so on.

Examples of the hydroxyamine include N,N-dibenzylhydroxylamine, N,N-diethylhydroxylamine, N,N-dioctylhydroxylamine, N,N-dilaulylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, mixtures containing two or more of them and so on.

Examples of the nucleating agent include sodium 2,2′-methylenebis(4,6-di-t-butylphenyl)phosphate, aluminum dihydroxy [2,2′-methylenebis(4,6-di-t-butylphenyl) phosphate], aluminum hydroxy bis[2,2′-methylenebis (4,6-di-t-butylphenyl)phosphate], aluminum tris[2,2′-methylenebis (4,6-di-t-butylphenyl)phosphate], sodium bis(4-t-butylphenyl)phosphate and the like, sodium benzoate, aluminum p-t-butylbenzoate and the like as metal salts of benzoic acid, 1,3:2,4-bis(0-benzylidene)sorbitol, 1,3:2,4 -bis(0-methylbenzylidene)sorbitol, 1,3:2,4-bis(0-ethylbenzylidene)sorbitol, 1,3-0-3,4-dimethylbenzylidene-2,4-0-benzylidenesorbitol, 1,3-0-benzylidene-2,4-0-3,4-dimethylbenzylidenesorbitol, 1,3:2,4-bis(0-3,4-dimethylbenzylidene)sorbitol, 1,3-O-p-chlorobenzylidene-2,4-0-3,4-dimethylbenzylidenesorb itol, 1,3-0-3,4-dimethylbenzylidene-2,4-0-p-chlorobenzylidene)sorbitol, 1,3:2,4-bis(0-p-chlorobenzylidene) sorbitol, mixtures of two or more of thereof and soon, compounds such as lithium salt, sodium salt, potassium salt, calcium salt, magnesium salt, aluminum salt and so on of rosin as alkali metal salts or alkaline earth metal salts of rosin.

Examples of the coloring improving agent include 9,10-dihydro-9-oxa-10-phosphophenanthrene-10-oxide and the like.

Examples of the auxiliary stabilizer include benzofuran compounds, indoline compounds and the like.

Methods for adding these additives are not particularly limited and these may be added either simultaneously with the hydroxide of alkaline earth metal (A) and/or the phenol antioxidant (B) or separately.

In addition, the polypropylene resin composition of the present invention can optionally contain other resins other than the polypropylene resin insofar as the object and effect of the invention are not adversely affected. Examples of the resin include a high density polyethylene, linear low density polyethylene which is a copolymer of ethylene with an α-olefin, low density polyethylene producible by high pressure radical polymerization, petroleum resin, hydrogenated styrene copolymer rubber formed by hydrogenating a styrene-butadiene-styrene block copolymer or a styrene-isoprene-styrene block copolymer, other elastomers and the like.

The method for producing the polypropylene resin composition is not particularly limited and known methods can be adopted. Examples thereof include melt-kneading methods using an extruder, Banbury mixer or the like. The melt index of the polypropylene resin composition may be adjusted by adding an organic peroxide on melt-kneading.

The method for producing a molded article of the polypropylene resin composition of the present invention is not particularly limited and known methods can be adopted. Examples thereof include an injection molding, compression molding, vacuum forming, foaming and the like, as well as a molding method in which an olefin resin of a similar kind or another resin is laminated.

Use, shape, size and the like of the molded articles of the polypropylene resin composition are not particularly limited and these molded articles can be used as automobile materials, materials for electric home appliances, materials for construction, bottles for various liquids, containers and the like. For example, the molded article can be used as interior parts such as an instrument panel or the like, exterior parts such as a bumper or the like in the automobiles material which are large molded articles, or washer, cleaner, toilet parts or the like in the materials for electric home appliances.

The method for producing a film of the polypropylene resin composition is not particularly limited and known methods can be adopted. Examples thereof include an extrusion-molding method such as T-die film forming method, tubular film forming method and the like. T-die film forming method which allows a high speed film production with a large scale film forming machine is preferably.

In addition, the polypropylene resin composition of the present invention can be also used as at least one layer component of a multi-layer film. As a method for producing a multi-layer film, a co-extrusion method is exemplified.

The thickness of the film is not particularly limited and is usually 10 to 500 μm, preferably 10 to 150 μm.

In the production of the film, the forming temperature is not particularly limited and usually from 180to 350° C. The polypropylene resin composition of the present invention is excellent in that it has less problem such as fuming, staining of processing machine such as roll particularly in the high temperature at 250° C. or above.

The polypropylene resin composition of the invention can be used as at least one layer component in a laminated film. When a laminated film is produced, another layer is not particularly limited and may include, for example, a uniaxially or biaxially oriented film of a polyolefin resin similar to the polypropylene resin such as a polypropylene biaxially oriented film and the like, an un-oriented or oriented nylon film, an oriented polyethylene terephthalate film, an aluminum foil and the like.

The method for producing a laminated film includes laminating methods such as the dry-laminating method, extrusion laminating method and the like.

The single film or laminated film is used, for example after processing into a bag or the like. The bag can be used, for example, for a package of foods, fiber products, sundry goods or the like, particularly for a package of confectionery, liquid foods, retort foods or the like.

The present invention will be described in more detail with reference of Examples and Comparative Examples, but is not limited thereto.

Phenol antioxidants (AO-1 and 2) and a phosphorus antioxidant (AO-3) used are as follows:

AO-1; pentaerythrityl-tetrakis[3-(3,5-di-t-butyl-4-hydroxyphenyl)propionate](manufactured by Ciba Specialty Chemicals K.K., trade name: IRGANOX 1010)

AO-2: 1,3,5-tris(3,5-di-t-butyl-4-hydroxybenzyl) isocyanurate (manufactured by Ciba Specialty Chemicals K.K., trade name: IRGANOX 3114)

AO-3: tris(2,4-di-t-butylphenyl)phosphite(manufactured by Ciba Specialty Chemicals K.K., trade name: IRGAFOS 168)

Methods for measuring respective items in Examples are as follows:

### (1) Melt Index (MI: g/10 Minutes)

This was measured according to JIS K7210 at 230° C. under a load of 2.16 kg.

### (2) Thermal Stability Test(Retention Test at High Temperature)

Into a cylinder of a melt—indexer kept at 280° C. were charged 6 g of pellets of a resin, which were loaded with an extruder and retained for 15 minutes in the heat-molten state. Then the molten resin was extruded, and the retained material was once solidified and then measured for melt index (230° C.). The smaller was the change in melt index between before and after retention, the better was judged the thermal stability.

### (3) Kneading Test (Discoloring Test)

In a 100 cc small type twin-screw kneader (Laboplastomil, manufactured by Toyo Seiki Co.) were melt-kneaded pellets of a polyolefin resin composition for 20 minutes under conditions of: amount of sample, 60 g; predetermined temperature, 200° C.; revolution number of rotor, 80 rpm. After 20 minutes, a bulk material formed by solidifying the kneaded mass was finely divided and formed into a sheet having a thickness of 1 mm by molding with a hot press. The sheet was measured for hue (yellow index: YI) with a color computer manufactured by Suga Testing Machine. The greater was the YI, the inferior was judged the hue.

Hot press molding: The kneaded material was charged in a mold (thickness: 1 mm) and subjected to hot pressing for 10 minutes at a temperature of 230° C. and a pressure of 50 kg/cm²G. After the hot pressing, the material was freed from the pressure and immediately cooled with a water-cooled press(30° C.).

### (4) Corrosion Test

### a) Preparation of an Iron Plate for Corrosion Test

One surface of an iron plate having a thickness of 2 mm (material: SS-41, size: 30×60 mm) was mirror-ground with a sheet of sand paper. (The iron plate was stored in a desiccator packed with silica gel.)

### b) Hot Press Molding

The mirror-ground surface of the iron plate was then contacted with an olefin resin filled in a mold (size: 20×25 mm; thickness: 3 mm) by hot press molding and subjected to hot pressing at a temperature of 280° C. under a pressure of 100 kg/cm²G for 10 minutes. After the hot pressing, the plate was freed from the pressure and immediately cooled in a water-cooled press (30° C.). This hot press molding was repeated 5 times using the same iron plate (the same contact surface).

### c) Conditioning (Aging)

After the hot pressing, the iron plate was allowed to stand for 24 hours in a desiccator (20° C.) filled with water.

### d) Judgment of the Degree of Corrosion

The degree of corrosion in the surface of the iron plate was ranked by visually comparing with a standard corrosion plates (in 5 scores). Criteria for the ranking of degree of corrosion are described below. The rank 2 or under was judged to be a practically non-problematic level.

| Rank | Degree of corrosion |
|---|---|
| 1 | Completely no corrosion |
| 2 | Partial clouding |
| 3 | Partial light corrosion |
| 4 | Light corrosion over the whole surface |
| 5 | Heavy corrosion over the whole surface |

### (5) Evaluation of Chill Roll Dirtiness

After producing a film having a thickness of 30μm using a T-die processing machine with a 50 mmφ extruder under conditions of a processing temperature of 290° C. and a chill roll temperature of 30° C. over 30 minutes, the chill roll was washed with xylene. A mass obtained by concentrating the xylene solution to dryness was weighed.

### (6) Evaluation of Fuming

The resin was melt-extruded with a 40 mmφ extruder at a predetermined temperature of 300° C. and fuming at the exit of die was visually judged. Criteria for the ranking of fuming are as follows:

| Rank | Fuming |
|---|---|
| +606 | Completely no fuming |
| Δ | A little fuming |
| X | Heavy fuming |

### EXAMPLE 1

To 100 parts by weight of polypropylene (propylene-ethylene block copolymer; Cl content: 11 μm by weight) were added 0.01 part by weight of calcium hydroxide (average particle diameter: about 5 μm) and 0.2 part by weight of the antioxidant AO-1. They were mixed with a Henschel mixer. The mixture was melt-kneaded under heating in a 40 mmφ single screw extruder under conditions including a predetermined temperature of 200° C. and a revolution number of 50 rpm to form pellets. The pellets had MI of 0.88 (g/10 minutes). The pellets were subjected to the thermal stability test (retention test at high temperature) and it was found that MI after the test was 1.47 (g/10 minutes) and the ratio of MI's was 1.7. The pellets were subjected to the kneading test and it was found that YI value of the sheet was −9. In addition, the pellets were subjected to the corrosion test and no corrosion was found. The results are shown in Table 1.

### Comparative Examples 1 to 5

The procedure in Example 1 was repeated except that calcium hydroxide was changed to magnesium hydroxide or zinc oxide and respective amounts were changed. The results are shown in table 1.

TABLE 1

| | Additive (part by weight) | | | | MI (g/10 minutes) | | | | |
|---|---|---|---|---|---|---|---|---|---|
| | Neutralizing | | Phenol | | Before | After | | | |
| | agent | | antioxidant | | retention | retention | Ratio | YI | Corrosion |
| Example 1 | Ca(OH)₂ | 0.01 | AO-1 | 0.2 | 0.88 | 1.47 | 1.7 | −9 | 1 |
| Comparative | ↑ | 0.05 | ↑ | ↑ | 0.87 | 1.46 | 1.7 | −5 | 1 |
| Example 1 | | | | | | | | | |
| Comparative | MgO | 0.03 | ↑ | ↑ | 0.83 | 1.73 | 2.1 | −5 | 2 |
| Example 2 | | | | | | | | | |
| Comparative | ↑ | 0.05 | ↑ | ↑ | 0.86 | 1.69 | 2.0 | −3 | 2 |
| Example 3 | | | | | | | | | |
| Comparative | ZnO | 0.03 | ↑ | ↑ | 0.92 | 2.02 | 2.2 | −7 | 2 |
| Example 4 | | | | | | | | | |
| Comparative | ↑ | 0.05 | ↑ | ↑ | 0.91 | 1.94 | 2.1 | −7 | 2 |
| Example 5 | | | | | | | | | |

### EXAMPLE 2

To 100 parts by weight of polypropylene (a propylene-ethylene block copolymer) were added 0.01 part by weight of calcium hydroxide (average particle diameter: about 5 μm), 0.2 part by weight of the antioxidant AO-1 and 0.05 part by weight of the antioxidant AO-3. They were mixed in a Henschel mixer. The mixture was melt-kneaded under heating in a 40 mmφ single-screw extruder under conditions including a predetermined temperature of 200° C. to form pellets. The pellets were subjected to the evaluation by the chill roll dirtiness. The results are shown in Table 2.

### EXAMPLE 3

### Comparative Example 6 to 9

The procedure in Example 2 was repeated except that the recipes of additives were changed to those described in Table 2. The results are shown in Table 2.

TABLE 2

| | | | | | | Roll |
|---|---|---|---|---|---|---|
| | Additive (part by weight) | | | | | dirtiness |
| | Neutralizing agent | | Antioxidant | | | (mg) |
| Example 2 | Ca(OH)₂ | 0.01 | AO-1 | — | AO-3 | 22 |
| | | | 0.2 | | 0.05 | |
| Example 3 | ↑ | ↑ | ↑ | — | — | 25 |
| Comparative | Calcium | 0.05 | ↑ | AO-2 | AO-3 | 60 |
| Example 6 | stearate | | | 0.075 | 0.05 | |
| Comparative | DHT4C | 0.05 | ↑ | ↑ | ↑ | 59 |
| Example 7 | | | | | | |
| Comparative | DHT4A | 0.05 | ↑ | ↑ | ↑ | 62 |
| Example 8 | | | | | | |
| Comparative | Mizukalac-S | 0.05 | ↑ | ↑ | ↑ | 56 |
| Example 9 | | | | | | |

In the Table 2, DHT 4A and DHT 4C are hydrotalcite (manufactured by Kyowa Chemical Co., Ltd.), and Mizukalac-S is a salt of lithium aluminum hydroxide (manufactured by Mizusawa Chemical Ind., Ltd.).

### EXAMPLE 4

To 100 parts by weight of the same polypropylene as used in Example 1 were added 0.01 part by weight of calcium hydroxide (average particle diameter: about 5 μm), 0.2 part by weight of the antioxidant AO-1 and 0.05 part by weight of the antioxidant AO-3. They were mixed in a Henschel mixer. The mixture was melt-kneaded under heat in a 40 mmφ single-screw extruder under conditions including a predetermined temperature of 200° C. to form pellets. The evaluation of the fuming was carried out using the pellets. The results are shown in Table 3.

### EXAMPLE 5

### Comparative Examples 10-11

The procedure in Example 4 was repeated except that the recipes of additives were changed to those described in table 3. The results are shown in Table 3.

TABLE 3

| | Additive (part by weight) | | | | |
|---|---|---|---|---|---|
| | Neutralizing agent | | Antioxidant | | Fuming |
| Example 4 | Ca(OH)₂ | 0.01 | AO-1 | AO-3 | ◯ |
| | | | 0.2 | 0.05 | |
| Example 5 | ↑ | ↑ | ↑ | — | ◯ |
| Comparative | Calcium | 0.05 | ↑ | — | Δ˜X |
| example 10 | stearate | | | | |
| Comparative | DHT4C | 0.05 | ↑ | — | Δ |
| example 11 | | | | | |

According to the present invention, a polypropylene resin composition having little change in hue during processing and being free of fuming during processing and free of dirt of a processing machine, a molded article and film prepared therefrom are provided.

What is claimed is:

1. A polypropylene resin composition comprising100 parts by weight of a polypropylene resin, 0.001 part by weight or more and less than 0.03 parts by weight of an alkaline earth metal hydroxide and 0.01 part by weight or more and less than 0.5 parts by weight of a phenol antioxidant.

2. The polypropylene resin composition according to claim 1, wherein the amount of the alkaline earth metal hydroxide and the phenol antioxidant are 0.001 to 0.02 part by weight and 0.01 to 0.3 part by weight, respectively.

3. The polypropylene resin composition according to claim 1, wherein the alkaline earth metal hydroxide is powdery calcium hydroxide.

4. The polypropylene resin composition according to claim 2, wherein the alkaline earth metal hydroxide is powdery calcium hydroxide.

5. The polypropylene resin composition according to claim 1, wherein the phenol antioxidant is a member selected from the group consisting of phenol compounds having at least one group represented by the general formula (I): 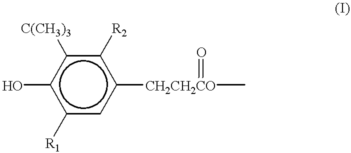
wherein R₁ and R₂ represent hydrogen, a methyl group or a t-butyl group, and they may be the same or different, and 1,3,5-tris(3,5-di-t-butyl-4-hydroxybenzyl) isocyanurate.

6. The polypropylene resin composition according to claim 2, wherein the phenol antioxidant is a member selected from the group consisting of phenol compounds having at least one group represented by the general formula (I): 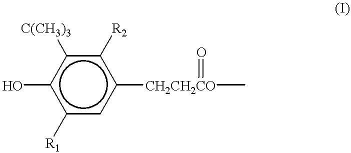
wherein R₁ and R₂ represent hydrogen, a methyl group or a t-butyl group, and they may be the same or different, and 1,3,5-tris(3,5-di-t-butyl-4-hydroxybenzyl) isocyanurate.

7. The polypropylene resin composition according to claim 3, wherein the phenol antioxidant is a member selected from the group consisting of phenol compounds having at least one group represented by the general formula (I): 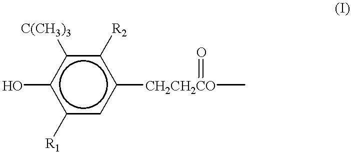
wherein R₁ and R₂ represent hydrogen, a methyl group or a t-butyl group, and they may be the same or different, and 1,3,5-tris(3,5-di-t-butyl-4-hydroxybenzyl) isocyanurate.

8. A molded article obtained by molding the polypropylene resin composition of claims 1.

9. A molded article obtained by molding the polypropylene resin composition of claims 2.

10. A molded article obtained by molding the polypropylene resin composition of claims 5.

11. A film prepared from the polypropylene resin composition of claims 1.

12. A film prepared from the polypropylene resin composition of claims 2.

13. A film prepared from the polypropylene resin composition of claims 5.
